(19) United States
(12) Patent Application Publication
(10) Pub. No.: US 2006/0124633 A1
(43) Pub. Date: Jun. 15, 2006

(54) Heating inductors, in particular of metal strips

(75) Inventors: Philippe Roehr, Lautenbach Zell (FR); Gerard Pfister, Buhl (FR); Aldo Grimaz, Lautenbach (FR); Remy Klein, Soultzmatt (FR)

Correspondence Address: CONNOLLY BOVE LODGE & HUTZ LLP, SUITE 800, 1990 M STREET NW, WASHINGTON, DC, 20036-3425, US

(73) Assignee: CELES, F-68610 Lautenbach (FR)

(21) Appl. No.: 10/509,157

(22) PCT Filed: Apr. 2, 2003
(86) PCT No.: PCT/FR03/01033

§ 371 Date: Apr. 22, 2005

(30) Foreign Application Priority Data
Apr. 4, 2002 (FR) 02/04218

(51) Int. Cl. H05B 6/10

(52) U.S. Cl. 219/645

(57) ABSTRACT

The invention concerns a heating system by induction of metal products, in particular metal strips with longitudinal magnetic flux, characterized in that the inductor (6) comprises between its coils, two magnetic field deflectors (7, 7′) whereof the shape and arrangement are selected such that they mask the inductor coils at the edges (2) of the strip (1).

The present invention relates to improvements to heating inductors, in particular for heating metal strip products.

When heating a metal strip by induction using a longitudinal magnetic flux inductor, overheating of the edges of the strip compared to its central part is observed. This overheating increases as the frequency of the inductor power supply current rises. Now this increase in frequency currently constitutes an important change to the technology in this particular technical field, given that it allows highly compact heating installations to be produced.

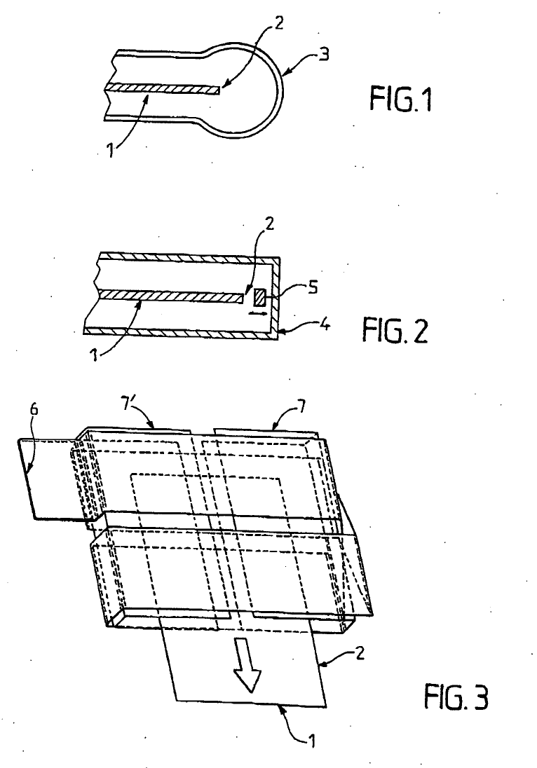

To solve this problem of overheating of the edges of the strip, a person skilled in the art currently uses in particular two solutions which are represented diagrammatically in FIGS. 1 and 2 in the appended drawings, these figures being vertical cross-sectional views of the heating inductors.

In the solution as claimed in FIG. 1, the shape of the coils of the inductor 3 is improved so as to adapt the value of the magnetic field at the edges 2 of the strip 1. In the solution thus illustrated, the inductor has a “dog bone” shape designed to apply a weaker magnetic field at the edges 2 of the strip than at the center of the latter. The drawback of this known solution lies in that it can generate perfect heating only for a defined width of the metal strip 1 to be heated.

The solution illustrated by FIG. 2 consists in deflecting the magnetic field by using high permeability bars such as 5, these bars, which are possibly moveable, being positioned along the edges 2 of the strip 1. In this known solution, the same drawback applies as in the solution described above with reference to FIG. 1: the correction is perfect only for a defined width of strip, which leads to the need to make the magnetic bars 5 moveable, as claimed in the width of the strip to be heated. This solution is therefore not practical for use on an industrial scale.

The present invention therefore proposes to provide a further solution to this problem of overheating of the edges of induction-heated strips, this solution not having the drawbacks of the known solutions described above and being suitable for use regardless of the width of the heated strip.

Consequently, the subject of the invention is an induction heating system for heating metal products, in particular metal strips, using a longitudinal magnetic flux, characterized in that the inductor includes, inside it, two magnetic field deflectors, the shape and arrangement of which are selected such that they mask the inductor coils at the edges of the strip.

As claimed in the present invention, the deflectors are U-shaped, with the branches covering the edges of the strip to be heated, which deflectors can be positioned along all or part of the length of the inductor.

Other features and advantages of the present invention will emerge from the description below, with reference to the appended drawing, FIG. 3 of which is a perspective diagrammatic view illustrating a non-limiting exemplary embodiment of a heating system as claimed in the invention.

Referring to FIG. 3, the reference numeral 6 denotes the heating inductor generating a longitudinal magnetic flux, inside which the strip 1 to be heated runs continuously.

As claimed in the invention, two magnetic field deflectors, respectively 7 and 7′, which are designed and positioned so as to mask, over all or part of the length of the inductor, the coils of the latter at the edges 2 of the strip to be heated, are introduced inside the inductor, between its coils, as can be seen clearly in FIG. 3. These deflectors therefore screen the magnetic field of the inductor, causing underheating of the edges.

In the exemplary embodiment illustrated by FIG. 3, the deflectors 7 and 7′ are U-shaped with the branches covering the edges 2 of the strip 1.

The advantages and technical effects provided by the invention are in particular as follows:
the correction to the heating is constant whatever the width of the heated strip, which means that the deflectors can be fixed and the solution provided by the invention can be used in industrial production;
by selecting an appropriate thickness of the deflectors, these are not the cause of excessive electrical losses, and
no adjustment is needed.

Naturally, the present invention is not limited to the exemplary embodiments described and represented above, but encompasses all variants thereof.

Thus, for example, the U-shaped screens located inside the inductor can have ends which are shaped so as to increase their effectiveness.

1. An induction heating system for heating metal products, in particular metl strips, using a longitudinal magnetic flux, characterized in that the inductor (6) includes, inside it, two magnetic field deflectors (7, 7′), the shape and arrangement of which are selected such that they mask the inductor coils at the edges (2) of the strip (1).

2. The heating system as claimed in claim 1, characterized in that the deflectors (7, 7′) are U-shaped, with the branches covering the edges (2) of the strip to be heated.

3. The heating system as claimed in claim 1, characterized in that the deflectors (7, 7′) are positioned along all or part of the length of the inductor (6).

4. The heating system as claimed in claim 1, characterized in that the U-shaped screens located inside the inductor have ends which are shaped so as to increase their effectiveness.
